(19) United States
(12) Patent Application Publication
(10) Pub. No.: US 2009/0277723 A1
(43) Pub. Date: Nov. 12, 2009

(54) Running rail for a lifting platform

(75) Inventor: Armin Straub, Pforzheim (DE)

Correspondence Address: OLIFF & BERRIDGE, PLC, P.O. BOX 320850, ALEXANDRIA, VA, 22320-4850, US

(73) Assignee: MAHA MASCHINENBAU HALDENWANG GMBH & Co. KG, HALDENWANG (DE)

(21) Appl. No.: 12/310,821

(22) PCT Filed: Aug. 9, 2007
(86) PCT No.: PCT/DE2007/001424

§ 371 Date: Mar. 9, 2009

(30) Foreign Application Priority Data
Sep. 11, 2006 (DE) 10 2006 043 228.2

(51) Int. Cl. B66F 7/28

(52) U.S. Cl. 187/216

(57) ABSTRACT

The invention relates to a running rail for a lifting platform, having at least one module carrier 1 which is connected to at least one lifting unit 2 in order to apply a force which at least assists the lifting process, and at least one module insert 3 which is connected to the module carrier 1 wherein the running rail has a high degree of modularity and variability and as a result has a high degree of flexibility of the field of use of the lifting platform.

The present invention relates to a running rail for a lifting platform, in which module inserts can be inserted into a module carrier whereby the modulation capability of the whole system is increased and thus variability is improved.

Arrangements of the type as mentioned have previously been known from the field of motor vehicle engineering in the shape of commercially available lifting platforms. These lifting platforms have a running rail of a fixed length which was integrated during assembly of the lifting platform and thus they cannot subsequently be varied any more. Due to this fixedly predetermined length of the running rail the problem arises that the lifting platform can no longer be used for application on certain groups of vehicles due to the nowadays ever increasing wheel bases of the vehicles. Due to this fact, these lifting platforms have only a short service life and must be replaced by larger exemplars at high costs or modified under high rebuilding expenses.

At the same time, the problem arises that due to the great length of the rail these lifting platforms cause a lot of effort in transport and, in connection thereto, high transport expenses due to their bulky dimensions.

A further disadvantage of these running rails can be seen in the fact that the usual running rails are lacquered or coated with powder or granulate material on their surfaces or covered by aluminum or a stainless steel sheet whereby the wheels exert tension and pressure forces on the surfaces of the running way linings when driving on such running rails. Thereby, the coatings are cut such that for example water, brake cleaners or defrosting agents may come into contact with the steel and the latter is thus exposed to corrosive environmental influences. This problem is furthermore made worse by foreign particles located in the tyre tread, such as e.g. sharp-edged stones by which the surface of the running rail may be attacked at a higher degree.

It is the object of the invention to provide a running rail and a lifting platform having an increased resistance to signs of wear wherein the variability and modulation capability can be improved at the same time.

This object is achieved by a device having the features of the independent claims.

Advantageous designs and preferred embodiments of the invention are stated in the subclaims.

In this case, the running rail has the advantage that the module insert can simply be adapted to the purpose of use and can be exchanged easily. To this end, the module insert provides a running base fitted into a module carrier. Moreover, the module carrier can be formed in different sizes whereby the variability of the running rail is increased and the field of use of the lifting platform can be expanded substantially. Additionally, benefits result insofar as the running rail can optimally be adapted to circumstances.

Furthermore, the module insert of the running rail may consist in particular of organic, inorganic and/or mineral materials. Thus, the advantages result that during the formation of these module inserts recourse can be taken to alternative materials which may be of especially low maintenance and/or particularly resistant to corrosion.

Furthermore, the running rail may have a module insert made particularly of plastics, wood, glass, stone and/or metal, which may furthermore contain electric and/or mechanic assemblies, in particular a joint play detector, a slide plate for axis measurement and/or a rotary table for axis measurement. Moreover, the module insert made of the materials as mentioned may be formed in a grid shape. Special advantages result here from the fact that the materials as mentioned may be resistant to corrosion influences, such as, for example, brake cleaners, defrosting agents or water. Furthermore, the grid-shaped formation is beneficial because corrosive liquids can drain off particularly easily and thus corrosive protection is especially optimized.

Furthermore, a contact surface can be formed between the module insert and the module carrier so that the draining of liquids is ensured. Thus, it is possible to discharge corrosive liquids from the running rail in a particularly easy manner whereby the corrosion of the running rail can be avoided and the lifetime or service life of the whole lifting platform can be substantially extended.

Moreover, the running rail may have a module carrier which may be formed of a profiled material. In this case, it is particularly advantageous that the profile shape of the module carrier especially improves the draining of corrosive liquids.

Furthermore, the module carrier may be formed in particular of steel, light metal and/or plastics.

Furthermore, the module carrier of the running rail may have an opening into which at least one module insert can be inserted in a substantially flush manner.

Moreover, the module carrier may have an opening into which at least two module inserts may be inserted next to and/or above one another.

From this fact advantages result particularly from the fact that it is possible to exchange the module inserts in the module carrier in an especially easy and simple way. In addition to that, it is possible to insert a plurality of different module inserts into a module carrier whereby different measurement apparatuses can be set into the module carrier.

Furthermore, the running rail may have a module carrier which is connected to the lifting unit via a carrier element.

Thus, it is possible to maximize variability during the assembly of the running rail in a particularly easy way. Additionally, advantages may be had with respect to transport costs and transport efforts which are considerably reduced because the individual modules have substantially smaller geometric dimensions than the running rail as a whole and thus can be transported as assemblies in a particularly manageable shape. Additionally, these components, which have smaller geometric dimensions, offer essential advantages in the case of hot-dip galvanizing because component distortion is decreased and thus the efforts during finishing treatments of the components are substantially reduced.

Furthermore, advantages result from the fact that due to the module carriers and module inserts which can be provided in different lengths, the overall length of the running rail can be varied over a particularly large range whereby the field of use of the running rail and thus of the whole lifting platform can be applied to a plurality of vehicles having a wide variety of wheel bases.

Furthermore, two module carriers may respectively be connected to the carrier element along the running direction.

Moreover, the module carrier of the running rail may have at least one protrusion which can be inserted or plugged into a respective retainer located on the carrier element. Thus, safe connection can be achieved wherein a quick exchange of the module carriers is made possible in particular. Furthermore, the protrusions may be designed in a profiled shape such that they can be inserted only in a certain predefined position into the retainer on the carrier element. This particularly has the advantage that faulty mounting of the module carrier on the carrier element is avoided.

Furthermore, the module carrier of the running rail may have at least one protrusion which can be inserted into a respective retainer located on the carrier element so that such contact is developed that the module carrier can be made level relative to the carrier element in at least one of its longitudinal, transverse and/or vertical axes. Thereby, it is possible to effect a subsequent correction of the positioning of the module carrier relative to the carrier element in a particularly simple manner. In addition to this, such arrangement offers the advantage that the position of the apparatus located in the module carrier may be aligned in its position together with the module carrier relative to the carrier element.

Furthermore, the module carrier may be made level by means of at least one setting element. In particular, the setting element may be formed in the shape of a setting screw, washers and/or a wedge. Preferably, the leveling is effected by means of 2 setting elements, particularly preferably four setting elements and most preferably six setting elements.

Moreover, the carrier element may be formed of a profiled material from which result advantages in particular with respect to the corrosion resistance of the carrier element because due to the profile of the material it is possible to provide particularly easy and fast draining of corrosive liquids from the carrier element.

Furthermore, the module insert may be formed to be pluggable so that positive and/or non-positive contact is made between the module insert and the module carrier and/or the module insert and/or the carrier element.

Furthermore, the module insert of the running rail may be attached to the module carrier and/or a carrier element by using at least one fastening element.

Moreover, the carrier element of the running rail may be connected in particular to a pantograph or scissors jack, a hydraulic cylinder and/or a wheel-free jack. A particular advantage in this case is the high variability in selecting the lifting systems that can be mounted on the carrier element, and in addition to that can subsequently be exchanged.

Furthermore, the module insert of the running rail may be formed such that it can be made level in at least one of its vertical, longitudinal and/or transverse axes. Here, an extremely fine adjustability of the module insert relative to the carrier element proves to be a particular advantage because in a two-step method the module insert on the one hand and the module carrier comprising the module insert on the other hand can be leveled relative to the carrier element. In this process the setting element may be disposed on the module carrier and/or on the module insert and/or on the carrier element in a direct connection to the module carrier and/or the module insert and/or the carrier element. Furthermore, the setting element may be provided as an additional component between the module insert and the module carrier and/or between the module insert and the carrier element and/or between the module carrier and the carrier element. Due to the leveling capability of the module inserts relative to the module carrier and of the module carrier relative to the carrier element, the positioning of the mentioned components to each other may be adapted over a particularly large range with high accuracy in such a way that it is particularly easy to balance manufacturing inaccuracies of the components and/or deformations of the components caused by use.

Moreover, the lifting unit of the lifting platform comprising a running rail may particularly have a pantograph or scissors, column and/or cylinder lifting platform.

In summary, the advantages of the invention shall be listed in the following. Due to the multi-part structure of the running rail and the lifting platform as well as their modular structure it is possible to considerably improve the variability of the running rail and the lifting platform, respectively, and thus the flexibility of the field of use. In addition to that, the modular structure enables the use of components having smaller geometric dimensions whereby advantages emerge for their hot-dip galvanizing because the distortion occurring therein will be less than in conventional running rails. Furthermore, it is possible to provide improved corrosion protection and thus to optimize resistance to signs of wear. Additionally, it is possible to reduce the efforts and costs during transport of the individual components. Moreover, it is possible to substantially increase the leveling characteristics of the running rail. Due to the fact that the running rail linings can be exchanged, it is possible to further reduce the occurrence of signs of wear and thus to extend the useful life of the lifting platform. Furthermore, due to the leveling capability of the running rail linings, it is possible to additionally improve the leveling characteristic.

Advantageous developments and further details of the present invention will be explained in more detail below by means of examples with reference to schematic figures, wherein:

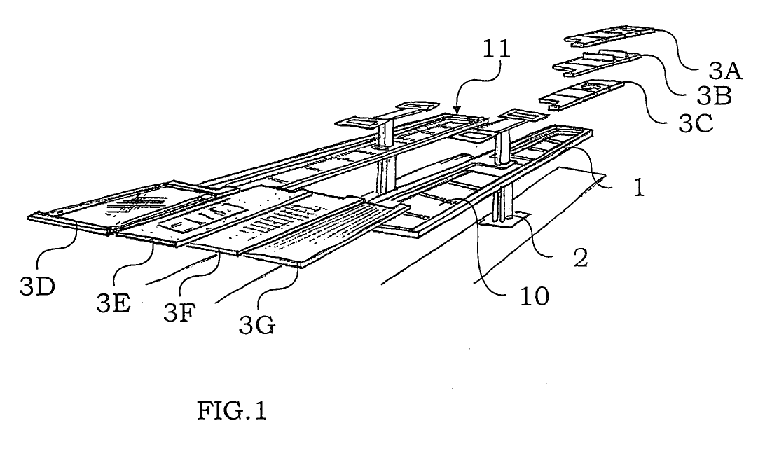

FIG. 1 shows a perspective view of a first embodiment of the running rail according to the invention.

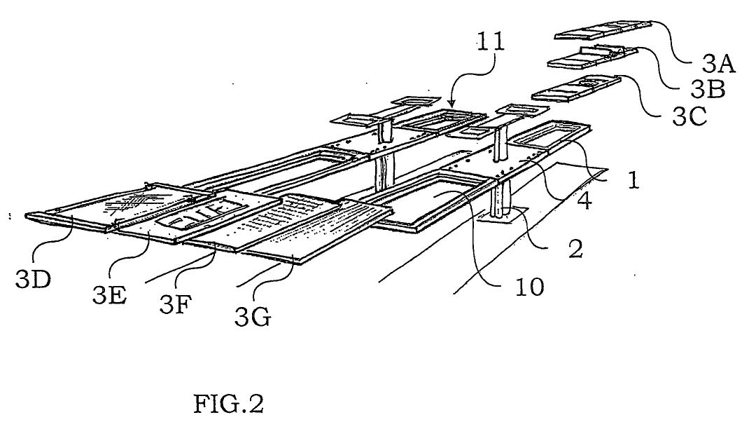

FIG. 2 shows a perspective view of a second embodiment of the device according to the invention.

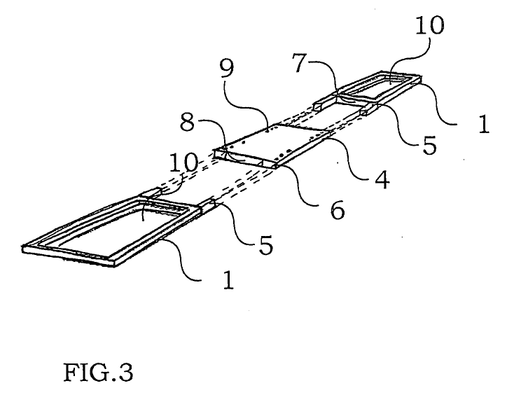

FIG. 3 shows a further perspective view of a second embodiment of the running rail.

FIG. 1 shows a perspective view of a running rail having a module carrier 1 consisting of a circumferential profile which is made in particular of a material like steel, light metal, aluminum and/or plastics and here has a rectangular shape. In a further embodiment, not shown, the module carrier 1 may also have a square shape or a trapezoidal shape or a shape with rounded corners and edges. For reinforcement, the module carrier 1 has transverse supports clamped between the long sides of the rectangular frame. Furthermore, on an upper side facing the vehicle, the module carrier 1 has an opening 10 into which the module inserts 3 are fitted. Moreover, the module carrier 1 has a guide rail on its upper side facing the vehicle for guiding a cylinder lifting unit for wheel-free lifting a vehicle located on the running rail 11.

On a lower side of the module carrier 1, which faces away from the vehicle, a fixture is attached which is connected to at least one lifting unit 2. The lifting unit 2 is a cylinder lifting platform. In a further embodiment, not shown, the lifting unit 2 as well as the lifting device may be formed in the shape of column and/or pantograph lifting platforms for a wheel-free lifting of the vehicle on the running rail 11. In a further embodiment, not shown, an axle lifting unit may be provided on the running rail 11.

It is possible to optionally fit a synthetic material insert 3A, a joint play detector 3B, a rotary table for axis measurement 3C, a slide plate for axis measurement 3D, a stone insert 3E, a steel grid 3F, a wood insert 3G or a glass insert into the module carrier 1. As can further be taken from FIG. 1, any combinations of the mentioned module inserts 3 may be set next to and/or above each other into the module carrier 1. In this case, the module inserts 3 have the shape of an L profile in order to match a corresponding counter-shape in the module carrier 1.

FIG. 2 illustrates another embodiment of a running rail 10 having a module carrier 1. Here, the module carrier 1 consists of a circumferential profile and has a rectangular shape. In a further embodiment, not shown, the module carrier 1 may also have a square shape or a trapezoidal shape or a shape having rounded corners and edges. The module carrier 1 is clamped into a carrier element 4, at the opposite end of which a second module carrier is plugged in. In this case, both module carriers 1 are mounted on the carrier element 4 along the running direction of a vehicle driving onto or off the same. A unit for wheel-free lifting a vehicle in the shape of a cylinder lifting platform is mounted on the carrier element 4. In a further embodiment, not shown, of the running rail 11, the unit for wheel-free lifting vehicles may be formed in the shape of a pantograph lifting platform or a cylinder lifting platform. In addition to that, in a further embodiment not shown, a wheel-free jack may be mounted on the carrier element 4 and/or the module carrier 1 instead of a unit for wheel-free lifting a vehicle. A lifting unit 2 for lifting the entire running rail 11 is attached to a lower side of the carrier element 4.

In another embodiment, not shown, of the second running rail the lifting unit 2 may also be formed as a column or pantograph lifting platform. Optionally, a synthetic material insert 3A, a joint play detector 3B, a rotary table for axis measurement 3C, a slide plate for axis measurement 3D, a stone insert 3E, a steel grid 3F, a wood insert 3G or a glass insert may be fitted into the module carriers 1. As can further be taken from FIG. 2, any combinations of the mentioned module inserts 3 may be fitted next to and/or above each other into a module carrier 1. On an upper side facing the vehicle, the module carrier 1 has an opening 10 into which at least one module insert 3 may be fitted. The module inserts 3 have a shape matching the shape of the openings 10 located in the module carrier 1 so that it is possible to set the module inserts 3 into the module carrier 1 in an easy, quick and safe manner, wherein sufficient flush und zero backlash between the module insert 3 and the module carrier 1 is ensured. In this case, the surface areas of the module inserts have a rectangular shape. In a further embodiment, not shown, of the module inserts 3, the surface area of these module inserts 3 may particularly have an L-shape, I-shape, T-shape or a shape which especially facilitates the fitting into the module carrier 1.

FIG. 3 schematically illustrates the assembly of the module carrier 1 into the carrier element 4. To this end, the module carriers 1 each have two protrusions 5 on a face 7 of the module carrier 1. The carrier elements 4 have recesses 6 on a face 8. The recesses 6 on the carrier element 4 and the protrusions 5 on the module carrier 1 have essentially the same shape so that a match analogous to a plug-and-socket connection is ensured. FIG. 3 illustrates an embodiment with a square profile of the protrusions 5 on the module carrier 1. Furthermore, on its upper side facing the vehicle and on an opposite lower side facing away from the vehicle and turned to the floor of, for example, a factory building, the carrier element 4 has setting screws with which the module carriers can be leveled in one of their longitudinal, transverse and/or vertical axes.

1. A running rail for a lifting platform, having
at least one module carrier which is connected to at least one lifting unit in order to apply a force which at least assists the lifting process,
and at least one module insert which is connected to the module carrier.

2. The running rail according to claim 1, wherein the module insert is formed in particular of organic, inorganic and/or mineral materials.

3. The running rail according to claim 1, wherein the module insert is formed in particular of synthetic material, wood, stone, glass and/or metal and/or contains an electric and/or a mechanic assembly, particularly a joint play detector, a slide plate for axis measurement and/or a rotary table for axis measurement.

4. The running rail according to claim 1, wherein a contact surface between the module insert and the module carrier is formed such that the draining of liquids is ensured.

5. The running rail according to claim 1, wherein the module carrier is formed of a profiled material.

6. The running rail according to claim 1, wherein the module carrier is formed in particular of steel, light metal and/or plastics.

7. The running rail according to claim 1, wherein the module carrier has an opening into which at least one module insert can be inserted in a substantially flush manner.

8. The running rail according to claim 1, wherein the module carrier has an opening into which at least two module inserts can be inserted next to and/or above one another.

9. The running rail according to claim 1, wherein the module carrier is connected to the lifting unit via at least one carrier element.

10. The running rail according to claim 1, wherein two module carriers are provided which are connected to the carrier element along the running direction.

11. The running rail according to claim 1, wherein the module carrier has at least one protrusion which can be inserted into a respective retainer located on the carrier element such that contact is made.

12. The running rail according to claim 1, wherein the module carrier has two protrusions which can be inserted into a respective retainer located on the carrier element so that such contact is developed that the module carrier can be made level relative to the carrier element in at least one of its longitudinal, transverse and/or vertical axes.

13. The running rail according to claim 1, wherein the leveling of the module carrier is made by means of at least one setting element.

14. The running rail according to claim 1, wherein the carrier element is formed of a profiled material.

15. The running rail according claim 1, wherein the module insert is formed to be pluggable, wherein at least positive and/or non-positive contact is made between the module insert and the module carrier and/or the carrier element.

16. The running rail according to claim 1, wherein the module insert is attached to the module carrier and/or the carrier element using at least one fastening element.

17. The running rail according to claim 1, wherein the carrier element is connected in particular to a pantograph jack, a hydraulic cylinder and/or a wheel-free jack.

18. The running rail according to claim 1, wherein the module insert can be made level in at least one of its vertical, longitudinal and/or transverse axes.

19. A lifting platform comprising a running rail according to claim 1, wherein the lifting unit in particular is a pantograph, column and/or cylinder lifting platform.

20. A running rail for a lifting platform, having
at least one module carrier which is connected to at least one lifting unit in order to apply a force which at least assists the lifting process,
and at least one module insert which is connected to the module carrier, wherein
the module carrier has an opening into which at least one module insert can be inserted in a substantially flush manner.

21. A running rail for a lifting platform, having
at least one module carrier which is connected to at least one lifting unit in order to apply a force which at least assists the lifting process,
and at least one module insert which is connected to the module carrier, wherein
the module carrier has an opening into which at least one module insert can be inserted in a substantially flush manner so that such contact is developed that the module insert can be made level relative to the module carrier in at least one of its longitudinal, transverse and/or vertical axes.

22. A running rail for a lifting platform, having
at least one module carrier which is connected to at least one lifting unit in order to apply a force which at least assists the lifting process,
and at least one module insert which is connected to the module carrier, wherein
the module carrier is connected to the lifting unit via at least one carrier element.

23. A running rail for a lifting platform, having
at least one module carrier which is connected to at least one lifting unit in order to apply a force which at least assists the lifting process,
and at least one module insert which is connected to the module carrier, wherein
the module carrier is connected to the lifting unit via at least one carrier element wherein the module carrier has at least one protrusion which can be inserted into a respective retainer located on the carrier element such that contact is made.

24. A running rail for a lifting platform, having
at least one module carrier which is connected to at least one lifting unit in order to apply a force which at least assists the lifting process,
and at least one module insert which is connected to the module carrier, wherein
the module carrier is connected to the lifting unit via at least one carrier element wherein the module carrier has at least one protrusion which can be inserted into a respective retainer located on the carrier element so that such contact is developed that the module carrier can be made level relative to the carrier element in at least one of its longitudinal, transverse and/or vertical axes.

25. A running rail for a lifting platform, having
at least one module carrier which is connected to at least one lifting unit in order to apply a force which at least assists the lifting process,
and at least one module insert which is connected to the module carrier, wherein
the module carrier is connected to the lifting unit via at least one carrier element wherein the module carrier has at least one protrusion which can be inserted into a respective retainer located on the carrier element so that such contact is made developed the module carrier can be made level relative to the carrier element in at least one of its longitudinal, transverse and/or vertical axes, wherein the module insert can be made level relative to the module carrier and/or the carrier element in at least one of its vertical, longitudinal and/or transverse axes.
